(19) United States
(12) Patent Application Publication
(10) Pub. No.: US 2023/0351281 A1
(43) Pub. Date: Nov. 2, 2023

(54) INFORMATION PROCESSING DEVICE, MACHINE LEARNING METHOD, AND INFORMATION PROCESSING METHOD

(71) Applicant: Hitachi, Ltd., Tokyo (JP)

(72) Inventors: Yuta TSUCHIYA, Tokyo (JP); Yasuhide MORI, Tokyo (JP); Masashi EGI, Tokyo (JP)

(73) Assignee: Hitachi, Ltd., Tokyo (JP)

(21) Appl. No.: 18/112,537

(22) Filed: Feb. 22, 2023

(30) Foreign Application Priority Data
Apr. 28, 2022 (JP) 2022-075509

(51) Int. Cl. G06Q 10/0631; G06Q 50/06

(52) U.S. Cl. CPC G06Q 10/06312; G06Q 10/06311; G06Q 50/06

(57) ABSTRACT

Provided is a technique that allows a user to easily determine what kind of future scenario AI is outputting. A preferred aspect of the invention provides an information processing device including: an agent configured to output a response based on a state observed from an environment with stochastic state transitions; an individual evaluation model configured to evaluate the response assuming that a part of the stochastic state transitions occurs; and a plan explanation processing unit configured to output information based on the evaluation in association with information based on the response.

### BACKGROUND OF THE INVENTION

### Field of the Invention

The present invention relates to a technique for evaluating a plan or an action output by a machine learning system and presenting an explanation.

### Description of Related Art

Reinforcement learning, which is one of machine learning systems, is a mechanism of learning parameters of a machine learning model (artificial intelligence (AI)) so that an action leading to an appropriate reward is output in an environment (task) in which an action is rewarded. Because of a high performance of the reinforcement learning, an application range is expanded to businesses such as social infrastructure and medical sites. For example, in order to minimize damage caused by an expected natural disaster or the like, it is possible to formulate an advance measure plan for appropriately allocating resources such as personnel in advance. However, in order to utilize the machine learning system in such a mission critical business, it is required to satisfy requirements for various properties such as transparency, fairness, and interpretability in addition to high utility. Therefore, a research on an eXplainable AI (XAI), which is a technique for explaining a basis of determination made by the machine learning system, is progressing rapidly.

As an XAI technique for reinforcement learning, in NPL 1, a portion of an image input to an AI model, which is regarded as important by an AI, is visualized by a heat map. In particular, an explanation technique for such input data has been actively developed in a framework of supervised learning. On the other hand, an action of the AI in the reinforcement learning is learned in consideration of a reward or an event to be obtained in the future, and therefore, attention has been focused on a “future-oriented explanation” with respect to a future event intended by the AI rather than a “past-oriented explanation” using the input data.

For example, NPL 2 proposes a method in which regarding a series of future events (state transitions) that will occur after an action to be explained (hereinafter referred to as a scenario), a scenario having the highest probability of occurrence is used for explanation.

NPL 3 proposes a method of visualizing an intention of an action of a reinforcement learning AI using a supervised learning AI model that outputs a table for all state transitions that may occur in the future and actions.

Further, PTL 1 proposes a method of dividing an AI that evaluates a value called a Q-value indicating the goodness of an action for each objective function. Accordingly, an action satisfying a plurality of objects at the same time is easily learned, and a suggestion to weight adjustment of each objective function is also given.

### CITATION LIST

### Patent Literature

PTL 1: JP2019-159888A

### Non Patent Literature

NPL 1: S. Greydanus, A. Koul, J. Dodge, and Alan Fern, “Visualizing and Understanding Atari Agents”, Proceedings of the 35th International Conference on Machine Learning, Stockholm, Sweden, PMLR 80, 2018.
NPL 2: J. V. D. Waa, J. V. Diggelen, K. V. D. Bosch, and M. Neerincx, “Contrastive Explanations for Reinforcement Learning in terms of Expected Consequences”, ArXiv, 1807.08706, 2018.
NPL 3: H. Yau, C. Russell, and S. Hadfield, “What Did You Think Would Happen? Explaining Agent Behaviour through Intended Outcomes”, Workshop on Extending Explainable AI Beyond Deep Models and Classifiers, Vienna, Austria, PMLR 119, 2020.

### SUMMARY OF THE INVENTION

The technique described in NPL 2 is insufficient for interpreting an intention of an AI. The reinforcement learning assumes various scenarios, selects an action effective in expected values, and includes, for example, a scenario in which an AI action is highly effective even when a probability is low, and a risk scenario in which rewards are still low. Therefore, no sufficient information to explain the intention of the AI can be obtained from only the scenario having the highest probability of occurrence. A function of selecting a scenario in accordance with an interest of a user instead of categorically selecting one scenario is required.

In the technique described in NPL 3, although states intended by the AI can be comprehensively compared with each other, a very large number of state transitions and actions are considered in reality, and thus it is difficult to apply the technique on site.

In a technique described in PTL 1, although an XAI is not considered, even when an intention of an AI is explained by using a plurality of objective functions, it is possible to extract one emphasized by the AI from the plurality of objective functions, but it is less likely to determine a specific future scenario assumed by the AI.

Therefore, an object of the invention is to provide a technique that allows a user to easily determine what kind of future scenario AI is outputting.

A preferred aspect of the invention provides an information processing device including: an agent configured to output a response based on a state observed from an environment with stochastic state transitions; an individual evaluation model configured to evaluate the response assuming that a part of the stochastic state transitions occurs; and a plan explanation processing unit configured to output information based on the evaluation in association with information based on the response.

More specifically, according to the above aspect, the agent and the individual evaluation model are machine learning models, the state is a feature obtained based on the environment, and the individual evaluation model evaluates the response with the feature and the response as inputs.

More specifically, when training the agent, the individual evaluation model, and an expected value evaluation model that evaluates a Q-value as an expected value by viewing entire stochastic state transitions, the agent and the expected value evaluation model are trained using training data, and the individual evaluation model is trained using only a part of the training data.

Another preferred aspect of the invention provides an information processing method executed by an information processing device including: a first learning model configured to receive a feature based on an environment with stochastic state transitions and output a response; and a second learning model configured to evaluate the response assuming that a part of the stochastic state transitions is fixed, and the information processing method includes: a first step of causing the first learning model to receive the feature and output the response; a second step of causing the second learning model to receive the feature and the response to obtain an evaluation value of the response; and a third step of outputting information based on the evaluation value in association with the response.

The invention can provide a technique that allows a user to easily determine what kind of future scenario AI is outputting. Problems, configurations, and effects other than those described above will be clarified by the following description of embodiments.

### BRIEF DESCRIPTION OF THE DRAWINGS

FIG. 1 is a block diagram showing an example of a system configuration (hardware) of a machine learning system evaluation device;

FIG. 2 is a table showing an example of a data structure of environment data;

FIG. 3 is a table showing an example of a data structure of feature data;

FIG. 4 is a table showing an example of a data structure of a plan;

FIG. 5 is a table showing an example of a data structure of an environment transition condition;

FIG. 6 is a flowchart illustrating an example of a work flow for training a plan generation agent, an expected value evaluation model, and an individual evaluation model;

FIG. 7 is a table showing an example of a data structure of an individual evaluation condition;

FIG. 8 is an image diagram showing an example of a screen output in a learning stage of machine learning models;

FIG. 9 is a flowchart illustrating an example of a work flow for error calculation and model update of the machine learning model;

FIG. 10 is a flowchart illustrating an example of a work flow for explaining an intention in an action or a plan output by a machine learning system;

FIG. 11 is a table showing an example of a data structure of scenario selection conditions;

FIG. 12 is an image diagram showing an example of a screen output of machine learning system evaluation results;

FIG. 13 is a block diagram showing an example of a system configuration (hardware) of a machine learning system evaluation device as compared with a user plan;

FIG. 14 is a flowchart illustrating an example of a work flow for explanting a machine learning system as compared with the user plan;

FIG. 15 is an image diagram showing an example of a screen output for explanting the machine learning system as compared with the user plan; and

FIG. 16 is a block diagram illustrating a schematic configuration of an embodiment.

### DESCRIPTION OF EMBODIMENTS

Embodiments will be described in detail with reference to the drawings. However, the invention should not be construed as being limited to the description of the embodiments shown below. A person skilled in the art could have easily understood that a specific configuration can be changed without departing from the spirit or gist of the invention.

In configurations of the embodiments described below, the same reference numerals are used in common among different drawings for the same parts or parts having similar functions, and redundant description may be omitted.

When there are a plurality of elements having the same or similar functions, the elements may be described by adding different additional subscripts to the same reference numeral. However, when it is unnecessary to distinguish the plurality of elements, the elements may be described by omitting the subscripts.

The terms “first”, “second”, “third”, and the like in the present specification are used to identify components, and do not necessarily limit numbers, orders, or contents thereof. Further, the numbers for identifying the components are used for each context, and the numbers used in one context do not always indicate the same configuration in other contexts. Further, it does not prevent the component identified by a certain number from having a function of a component identified by another number.

In order to facilitate understanding of the invention, a position, a size, a shape, a range, etc. of each component shown in the drawings may not represent an actual position, size, shape, range, etc. Therefore, the invention is not necessarily limited to the position, size, shape, range, etc. disclosed in the drawings.

All publications, patents, and patent applications cited in the present specification form a part of the present specification as they are.

Components represented in a singular form in the present specification shall include a plural form unless explicitly indicated in the context.

In the following description, a reinforcement learning system that formulates an advance measure plan for appropriately allocating resources such as personnel in advance in order to minimize damage caused by an expected natural disaster or the like will be described, but methods can be widely applied to a general reinforcement learning target problem in which an action or a plan (which is a scheduled action and may be simply referred to as an action in combination) is output in accordance with a state observed from an environment, such as action selection of a robot or a game AI, operation control of a train or an automobile, or a shift schedule of an employee.

An information processing device, a machine learning method, and an information processing method according to the embodiments include an agent portion that outputs an action or a plan in accordance with a state observed from an environment with state transitions based on conditions such as a probability, a portion that specifies, by a user, a state transition condition under which the action or the plan is divided and evaluated, a portion that estimates a value of an action or a plan for each of future state transitions divided based on the specified condition, a portion that processes a question from the user, a portion that selects a state transition corresponding to a question processing result to calculate a future state and a reward, and a portion that uses the obtained information to generate an explanation of an intention of the action or the plan.

According to such a configuration, even in a problem setting in which there are very many state transitions with respect to an action or a plan output by an AI, by evaluating a value for each of the state transitions divided based on the condition specified by the user, a specific future scenario assumed by the AI is presented based on an interest of the user, and it is possible to obtain useful information for interpreting an intention of the action output by the AI.

Hereinafter, several embodiments of the invention will be described with reference to the drawings. However, these embodiments are merely examples for implementing the invention, and do not limit the technical scope of the invention. A person skilled in the art could have easily understood that a specific configuration can be changed without departing from the spirit or gist of the invention.

In configurations of the invention described below, the same or similar configurations or functions are denoted by the same reference numerals, and a repeated description thereof is omitted.

In order to facilitate understanding of the invention, a position, a size, a shape, a range, etc. of each component shown in the drawings may not represent an actual position, size, shape, range, etc. Therefore, the invention is not limited to the position, the size, the shape, the range, etc. disclosed in the drawings.

Hereinafter, embodiments of the invention will be described with reference to the drawings.

### First Embodiment

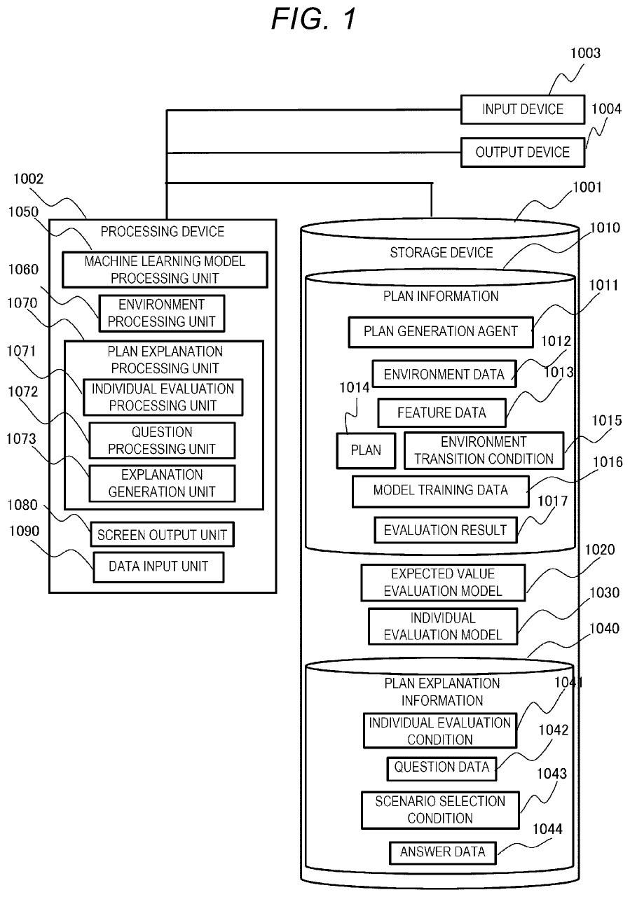

FIG. 1 is a configuration example of a machine learning system evaluation device for implementing an embodiment of the invention. The machine learning system evaluation device includes a storage device 1001, a processing device 1002, an input device 1003, and an output device 1004.

The storage device 1001 is a general-purpose device that permanently stores data, such as a hard disk drive (HDD) and a solid state drive (SSD), and includes plan information 1010, an expected value evaluation model 1020, which is a machine learning model that evaluates an expected value goodness of a plurality of state transitions for a plan output by an AI, an individual evaluation model 1030, which is a machine learning model that divides and evaluates the plan output by the AI for each of the state transitions based on a condition specified by a user, and plan explanation information 1040. The storage device 1001 may not be present on a terminal similar to other devices, but on a cloud or an external server, and data may be referred to via a network.

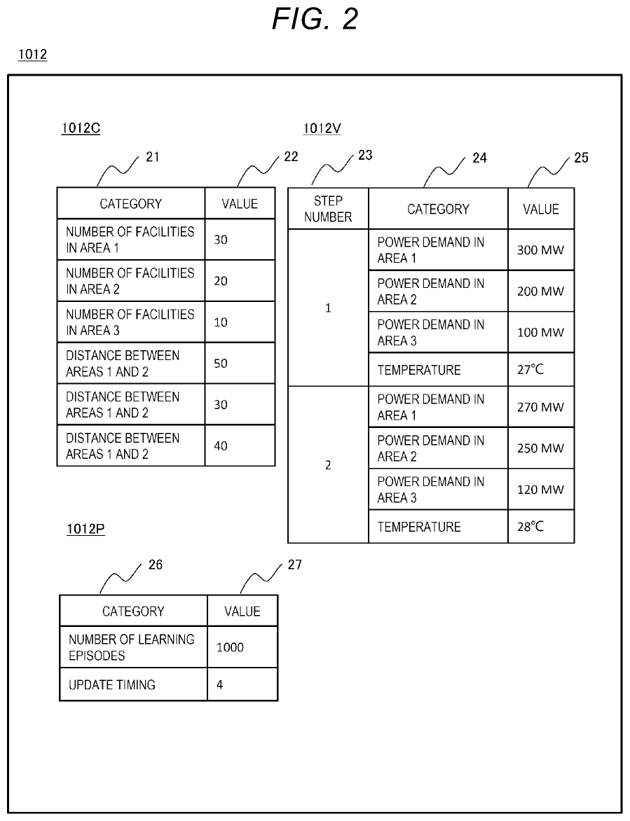

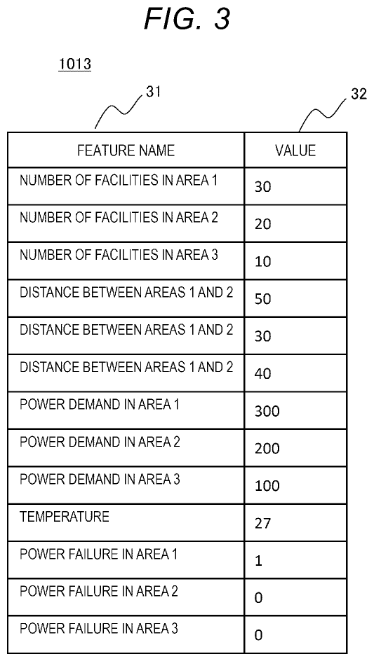

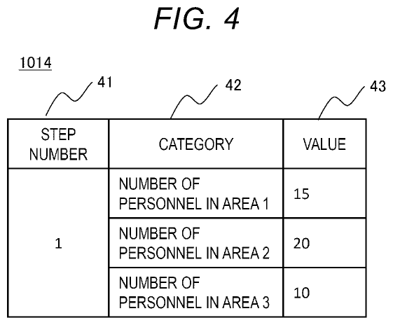

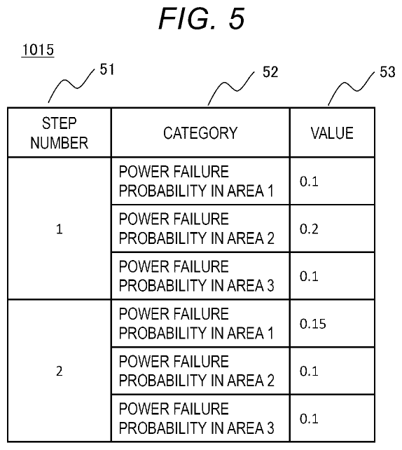

The plan information 1010 includes a plan generation agent 1011 that outputs a plan in accordance with a state observed from an environment, environment data 1012 (see FIG. 2) in which information on the environment is stored, feature data 1013 (see FIG. 3) that is input data of the agent, a plan 1014 (see FIG. 4) output from the agent, an environment transition condition 1015 (see FIG. 5) that specifies a state transition condition of the environment, model training data 1016 that is input data for training each machine learning model, and an evaluation result 1017 of the plan made by an evaluation model.

The plan explanation information 1040 includes an individual evaluation condition 1041 which is a condition for dividing and evaluating the plan output by the AI for each of the state transitions, question data 1042 from the user for the plan output by the AI, a scenario selection condition 1043 in which a state transition condition specified based on a question is stored, and answer data 1044 which is an answer to the question.

The processing device 1002 is a general-purpose computer, and includes therein a machine learning model processing unit 1050, an environment processing unit 1060, a plan explanation processing unit 1070, a screen output unit 1080, and a data input unit 1090, which are stored in a memory as software programs.

The plan explanation processing unit 1070 includes an individual evaluation processing unit 1071 that performs processing of the individual evaluation model 1030, a question processing unit 1072 that performs processing of the question data 1042 from the user and the scenario selection condition 1043, and an explanation generation unit 1073 that generates the answer data 1044 to the user.

The screen output unit 1080 is used to convert the plan 1014 and the answer data 1044 into a displayable format.

The data input unit 1090 is used to set parameters and questions from the user.

The input device 1003 is a general-purpose input device for a computer, such as a mouse, a keyboard, and a touch panel.

The output device 1004 is a device such as a display, and displays information for interacting with the user through the screen output unit 1080. When it is not necessary for humans to check evaluation results of a machine learning system (for example, when the evaluation results are directly transferred to another system), an output device may not be provided.

The above configuration may be implemented by a single device, or any part of the device may be implemented by another computer connected thereto via a network. In the present embodiment, functions equivalent to those implemented by software can also be implemented by hardware such as a field programmable gate array (FPGA) and an application specific integrated circuit (ASIC).

FIG. 2 is a table showing an example of the environment data 1012. The environment data 1012 includes data 1012C that does not change over time, data 1012V that changes over time, and a machine learning parameter 1012P. Here, an example in which a plan for appropriately allocating resources for power transmission and distribution in areas 1 to 3 is formulated will be considered.

The data 1012C that does not change over time is a database including a category 21 indicating category information of each data item and a value 22 thereof. As an example, the number of facilities such as power plants for each area and a distance between areas are recorded.

The data 1012V that changes over time is a database including a step number 23 representing a time cross-section, a category 24 of data items, and a value 25. As an example, a power demand for each time-varying area and a temperature for each time-varying area are recorded.

The machine learning parameter 1012P is a database including a category 26 of parameters to be used at the time of machine learning and a value 27 thereof.

The environment data 1012 is, for example, information to be input by the user or acquired from a predetermined information processing device. In addition, a data format is not limited to table data, and may be, for example, image information or a calculation formula.

FIG. 3 is a table showing an example of the feature data 1013. The feature data 1013 is a database including a category 31 of features and a value 32 thereof. The feature data 1013 is generated by the environment processing unit 1060 based on the environment data 1012, and the value 32 is a data format (mainly, a numerical value or category data) that can be input to the plan generation agent 1011. The “state” in the present specification indicates the feature data 1013 for each time step.

FIG. 4 is a table showing an example of the plan 1014. The plan 1014 is a database including a step number 41 representing a target time step, a category 42 of plan items, and a value 43 thereof. The plan 1014 is output for each time step by the plan generation agent 1011. The plan 1014 in the example is a plan for appropriately allocating resources (personnel) for power transmission and distribution in a certain area.

FIG. 5 is a table showing an example of the environment transition condition 1015. The environment transition condition 1015 is a database including a step number 51 representing a target time step, a category 52 of transition condition items, and a value 53 thereof. The environment transition condition 1015 is defined by a probability or a conditional expression, and is reflected in the feature data 1013 for a next time step by the environment processing unit 1060. The “occurrence of an event” in the present specification indicates that an environment transition occurs. An environment transition condition in the example indicates a power failure probability in each area for each step.

Hereinafter, an operation process of the machine learning system evaluation device will be described. The present embodiment is roughly divided into a learning stage and an explanation stage.

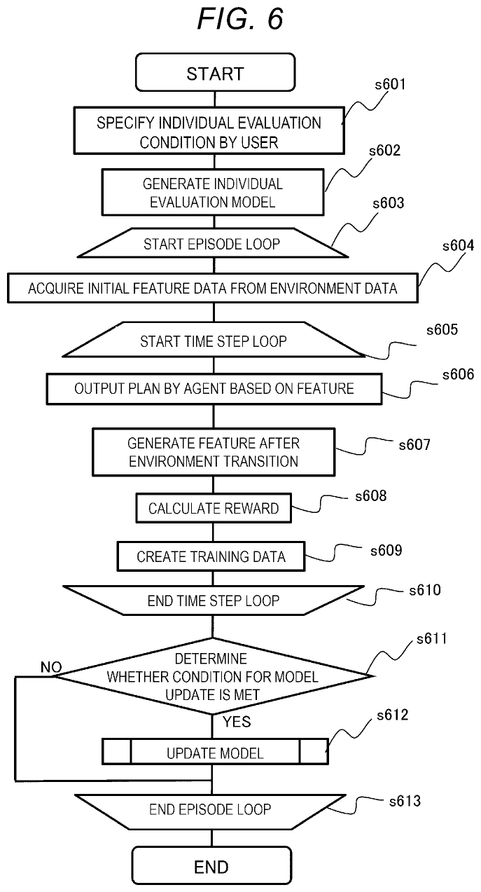

FIG. 6 is a flowchart illustrating an example of a training process of the plan generation agent 1011, the expected value evaluation model 1020, and the individual evaluation model 1030. In the present embodiment, training data is accumulated by repeating, a plurality of times, an episode in which an agent outputs an action or a plan in accordance with a state observed from an environment for each time step (s603 to s610), a sequential error function is calculated and a machine learning model is updated (s612), and a model with high accuracy is trained.

An operation based on the flowchart is as follows.

Step s601: the user specifies the individual evaluation condition 1041.

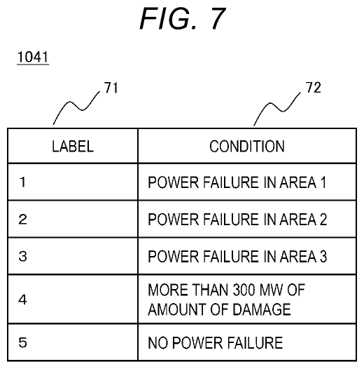

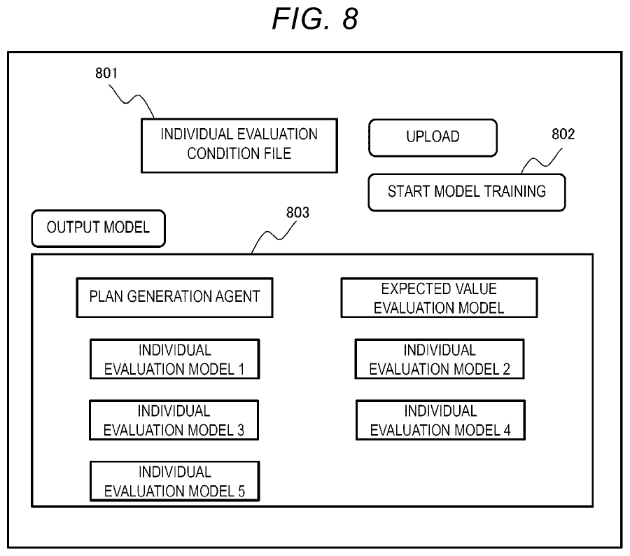

This is performed by using a method of interactively setting on a GUI or transmitting data from another information processing device in a format such as a file. Automatic classification based on an algorithm such as clustering may be used. The details will be described with reference to FIGS. 7 and 8.

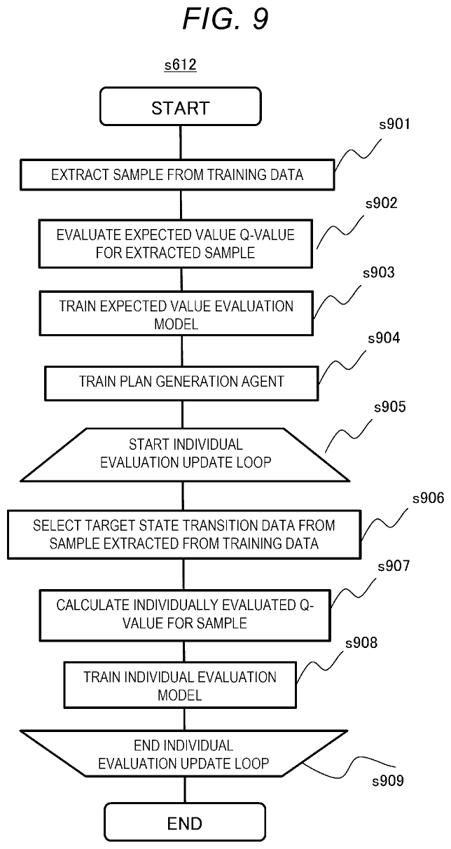

Step s602: the individual evaluation processing unit 1071 generates the individual evaluation model 1030 based on the individual evaluation condition 1041. The number of models is determined based on a condition determined by the individual evaluation condition 1041. Examples of the individual evaluation condition 1041 and the number of models generated thereby will be described with reference to FIGS. 7 and 8. The individual evaluation model 1030 is assumed to be a machine learning model such as a neural network. The individual evaluation model 1030 can handle the same feature as that of the expected value evaluation model 1020 as input data, and output data basically includes a scalar value called a Q-value stored in the evaluation result 1017, similarly to the expected value evaluation model 1020. The details of the Q-value will be described with reference to FIG. 9.

Step s603: an episode loop for accumulating training data and updating a model is started.

Step s604: the environment processing unit 1060 outputs the feature data 1013 (FIG. 3) with data for a first time step from the data 1012C that does not change over time and the data 1012V that changes over time as inputs in the environment data 1012.

Step s605: a loop for processing each time step in one episode is started.

An episode includes a plurality of time steps. The number of time steps is specified by the data 1012V that changes over time and the machine learning parameter 1012P in the environment data. For example, an episode is from the arrival of a typhoon until it passes away, and the time steps are 13:00, 14:00, 15:00, and so on. The environment transition condition 1015 determines how an environment changes (where power failure occurs) when a time step changes.

Step s606: the plan generation agent 1011 outputs the plan 1014 with the feature data 1013 as an input. The agent is a machine learning model such as a general neural network.

Step s607: the environment processing unit 1060 generates the feature data 1013 for a next time step with a data item for a next time step from the data 1012V that changes over time in the environment data 1012, the plan 1014 output in step s606, and the environment transition condition 1015 as inputs.

Step s608: the environment processing unit 1060 calculates a reward with the feature data 1013 for the current time step and the next time step and the plan 1014 as inputs. The reward is a value representing a profit or a penalty obtained by a plan output by the agent before and after a state transition, and is generally a scalar value. In the present embodiment, the same applies to a cost of allocating resources such as personnel, an amount of damage that can be reduced by appropriate allocation, and the like. The processing of Steps s606 to s608 applies reinforcement learning known as an actor-critic.

Step s609: the environment processing unit 1060 combines the feature data 1013 for the current time step and the next time step, the plan 1014, the reward value generated in Step s608, and a label corresponding to the individual evaluation condition 1041 (see FIG. 7) into one tuple or the like. A condition determination of the label is based on the state transition processed in Step s607. The created training data is accumulated as the model training data 1016 by the environment processing unit 1060.

Step s610: the process is repeated by the step number specified by the data 1012V that changes over time and the machine learning parameter 1012P in the environment data. The step number may be specified by a conditional expression or the like. The environment processing unit 1060 determines end or continuation.

Step s611: the environment processing unit 1060 determines whether a condition of a model update frequency specified by the machine learning parameter 1012P is met. If the condition is met, the process proceeds to Step s612, and if not, the process proceeds to Step s613.

Step s612: the machine learning model is trained and updated using the accumulated data. The detailed process will be described with reference to FIG. 9.

Step s613: the process is repeated by the number of episodes specified by the machine learning parameter 1012P. The environment processing unit 1060 determines end or continuation.

FIG. 7 is a table showing an example of the individual evaluation condition 1041. The individual evaluation condition 1041 is a database including a label 71 for each condition and a condition 72 that is a condition content.

The label 71 is stored in the training data in step s609 in FIG. 6, and is used as a mark as to which individual evaluation condition corresponds.

The condition 72 corresponds to the environment transition condition 1015, and stores information such as which event occurs and the magnitude of influence caused by an environment transition. In addition, a plurality of the environment transitions may correspond to one condition.

The condition 72 is specified by the user based on, for example, the previously set environment transition condition 1015. The condition 72 can describe a condition that is independent of a time step (which can be applied in any time step) or a condition for each time step. The condition 72 can describe a condition associated with a variable name or a value of a specific program (when a variable “A” becomes equal to or larger than a value “X”), or a condition corresponding to the environment transition condition 1015 (when “power failure in the area 1” described in the environment transition condition occurs).

In the example of FIG. 7, the conditions that are independent of the time steps are written. Therefore, when the “power failure in the area 1” occurs at some time step based on the environment transition condition 1015, a “label 1” is attached to the training data in Step s609 based on the individual evaluation condition 1041. When the individual evaluation condition 1041 is defined for each time step such as the “power failure in the area 1 in time step 1” and “power failure in the area 1 in time step 2”, a label is attached in accordance with the occurrence of an environment transition condition in the time step.

FIG. 8 is a diagram showing an example of an interface through which the user inputs individual evaluation condition 1041 and a file output of model learning results. The example includes a file input unit 801 of the individual evaluation condition 1041, a button 802 for starting a model learning, and a file 803 of a trained output model. In FIG. 8, five labels are specified by the individual evaluation condition 1041 in FIG. 7, and thus five individual evaluation models are created.

FIG. 9 is a flowchart illustrating an example of an error calculation and model update process of the machine learning model performed in Step s612 in FIG. 6. An error function is calculated using data sampled from the training data, and each model parameter is updated. Although a neural network is used as an example of a machine learning model to be used, there is no detailed specification as long as it can be used for reinforcement learning.

Step s901: the machine learning model processing unit 1050 samples any data from the model training data 1016. A total number and conditions may be specified by the environment data 1012.

Step s902: the expected value evaluation model 1020 outputs a Q-value for each of the sampled training data with the feature data 1013 before state transition and the plan 1014 as inputs. The Q-value is a general scalar value in reinforcement learning representing the goodness of the plan in the state, and may be any value other than the Q-value as long as it represents the goodness of the plan. The evaluated training data is stored in the evaluation result 1017 in association with the Q-value. It is assumed that the expected value evaluation model 1020 is generated by using a known method, for example, by an environment processing unit.

Step s903: the machine learning model processing unit 1050 calculates an error function using the evaluation result 1017, and updates the model. For example, in a framework of general Q-learning, when it is assumed that a pre-transition time step is t, a post-transition time step is t+1, a reward is Rₜ₊₁, a learning rate is y, a pre-transition state is sₜ, a post-transition state is sₜ₊₁, a plan is aₜ, a plan for a next time step is aₜ₊₁, and a Q-value is Q, an error function is expressed according to the following Equation 1.

$${( {R}_{t + 1} + γ {max}_{{a}_{t + 1}} {Q}_{EX \_ target} ( {s}_{t + 1} , {a}_{t + 1} ) - {Q}_{EX} ( {s}_{t} , {a}_{t} ) )}^{2} \qquad ( 1 )$$

Here, Q_{EX} is the Q-value calculated in Step s902, and Q_{EX_target} is a 0-value evaluated for the state sₜ₊₁ for a next time step and the plan aₜ₊₁ to be output by the plan generation agent 1011 with the state sₜ₊₁ as an input. In the general Q-learning, for the purpose of stabilizing learning, the evaluation of the Q_{EX_target} is referred to as a target network, which is the expected value evaluation model 1020 immediately before the model used in Step s902 is updated. The learning rate y is a parameter for machine learning that is included and specified in the environment data 1012.

Step s904: the machine learning model processing unit 1050 trains the plan generation agent 1011. In the general Q-learning, a value obtained by multiplying an average Q-value of the data stored in the evaluation result 1017 in Step s902 by −1 is learned as an error function. The plan generation agent advances learning so that a plan having a larger Q-value is formulated.

Step s905: a model update processing is performed for each individual evaluation model 1030.

Step s906: the machine learning model processing unit 1050 extracts data having corresponding individual evaluation labels from the model training data 1016 sampled in Step s901.

Step s907: the individual evaluation model 1030 outputs the Q-value for each of the sampled training data with the feature data 1013 before state transition and the plan 1014 as inputs. The evaluated training data is stored in the evaluation result 1017 in association with the Q-value.

Step s908: the machine learning model processing unit 1050 calculates an error function using the evaluation result 1017, and updates the individual evaluation model 1030. In general, the processing of Step s903 may be performed for each individual evaluation model.

When the individual evaluation model before update is used as a target network, learning is performed to minimize an error in a direction different from that of the expected value evaluation model 1020. Therefore, by calculating an error between a part that estimates a value for each state transition and an expected value using the expected value evaluation model 1020 as a target network, it is possible to perform Q-value decomposition at a granularity matching the interest of the user, which is the purpose of the present embodiment, using a value in which a consistency between an expected Q-value and an individual Q-value is maintained. In addition, the individual evaluation models are independent of each other, and thus it is possible to speed up learning through a parallel processing.

Step s909: when the model update processing is performed for all the individual evaluation models 1030, the process ends. A model for which no data can be sampled in Step s906 may not be updated.

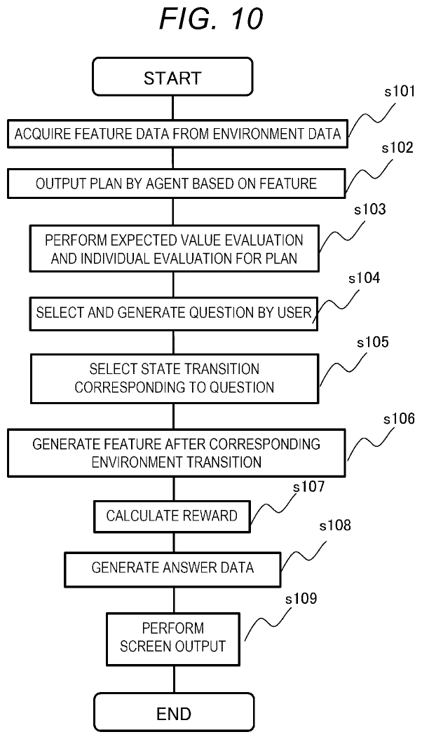

FIG. 10 is a flowchart illustrating an example of an explanation process of the machine learning system that utilizes the trained individual evaluation model 1030. In the explanation stage, a question from the user is processed, a corresponding state transition is simulated for each state transition from an individually evaluated Q-value vector, and results are displayed. Through this process, it is possible to interpret what kind of future scenario is expected to be planned by the AI.

Step s101: the environment processing unit 1060 generates the feature data 1013 for a time step to be explained based on the environment data 1012. A target time step and conditions are specified by the user using the data input unit 1090 or specified by another information processing device.

Step s102: the plan generation agent 1011 outputs the plan 1014 with the feature data 1013 as an input.

Step s103: the expected value evaluation model 1020 and the individual evaluation model 1030 output the Q-value with the feature data 1013 and the plan 1014 as inputs. In the individual evaluation model to be used, the environment processing unit 1060 refers to the environment data 1012, and uses only those corresponding to the state transitions that may occur in the current time step.

Step s104: the user inputs the question data 1042 by the input device 1003. A method of uploading a file on the GUI using the data input unit 1090 or inputting a file in a natural language is used for inputting a question.

Step s105: the question processing unit 1072 selects an appropriate state transition from the individually evaluated Q-value vector output from the individual evaluation model 1030 in step s103 using the question data 1042 from the user and the scenario selection condition 1043 (see FIG. 10) as inputs.

Step s106: in order to simulate the selected state transition, the environment processing unit 1060 generates the feature data 1013 for a next time step using the environment data 1012 and the plan 1014.

Step s107: the environment processing unit 1060 calculates a reward with the feature data 1013 for the current time step and the next time step and the plan 1014 as inputs.

Step s108: the explanation generation unit 1073 generates the answer data 1044 for the user.

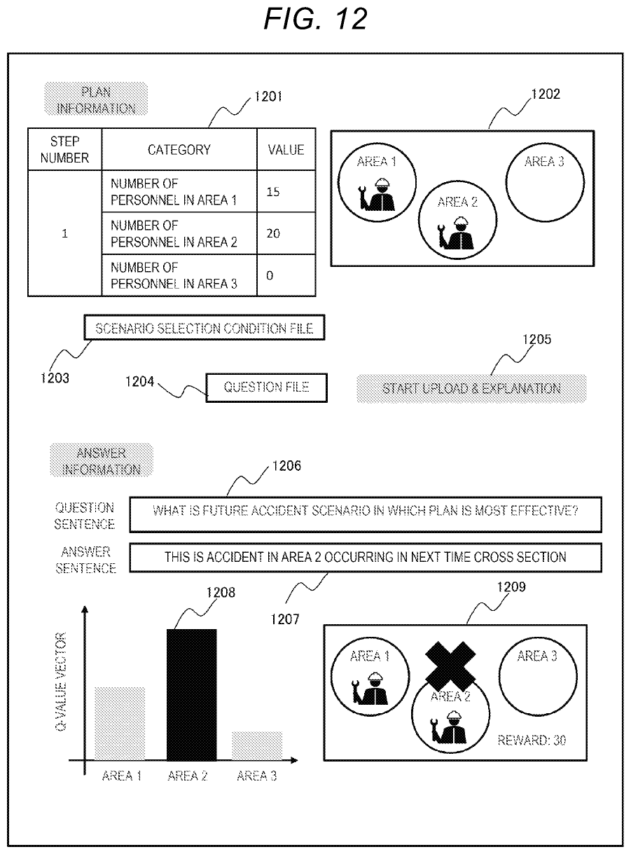

Step s109: the screen output unit 1080 converts the answer data 1044 or the like into a GUI format and displays the converted the answer data 1044 on the output device 1004 (see FIG. 12).

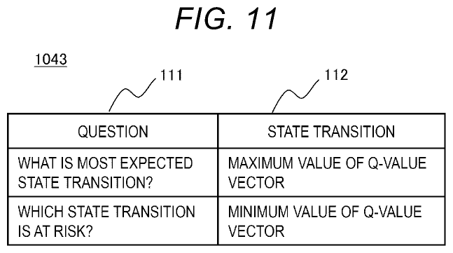

FIG. 11 is a table showing an example of the scenario selection condition 1043. The scenario selection condition 1043 is a database including a question 111 from the user and a corresponding state transition 112. The question processing unit 1072 can select an appropriate state transition 112 from the scenario selection condition 1043 by converting the question data 1042 from the user into a format corresponding to the question 111. For example, by displaying a state transition indicating a maximum value of the Q-value for a question “what is a most expected state transition”, it is possible to know a specific event in which the plan 1014 exhibits a most effective effect. The scenario selection condition 1043 is not limited to a format of table data, and may be a conditional expression or the like. In addition, the state transition 112 may be a Q-value that satisfies a predetermined condition, not limited to the maximum or minimum.

FIG. 12 is a diagram showing an example of a screen output such as the answer data 1044 generated by the explanation generation unit 1073. The screen output includes an example 1201 of the output plan 1014, an example 1202 in which the plan 1014 is graphically visualized, a file input unit 1203 of the scenario selection condition 1043, a file input unit 1204 of the question data 1042 from the user, and a button 1205 for starting file upload and explanation.

The screen output includes a display example 1206 of a question sentence from the user, an answer sentence 1207, a Q-value vector 1208 in which a state transition selected with the Q-values of the plurality of individual evaluation models 1030 is highlighted, and an example 1209 in which an environment after the selected state transition and a reward are graphically visualized.

First, with respect to the example 1201 and the example 1202 to be displayed based on the plan 1014 output from the plan generation agent 1011, the user uploads the scenario selection condition 1043 and the question data 1042 using the file input unit 1203 and the file input unit 1204.

Next, the question processing unit 1072 determines the state transition 112 while comparing the question data 1042 with the scenario selection condition 1043, and displays the answer sentence 1207, the Q-value vector 1208, and the display example 1209 as the answer data 1044.

In the example, since the user is listening to a most expected scenario, the state transition indicating the largest Q-value is selected and also highlighted in the Q-value vector 1208. The plan information and the answer information may not be displayed on a screen at the same time, and may be presented by switching between two screens.

In the present embodiment, although the Q-value is presented to the user, this value is abstract, and thus the value may not be suitable for explanation. In this case, in addition to outputting the Q-value in Step s103 in FIG. 10, the environment processing unit 1060 may be used to convert the Q-value into a value that is easier for the user to interpret. For example, in the embodiment, a power failure recovery time and a resource rate of operation such as personnel are applicable. In addition, it is possible to display probability values of the state transitions separately, obtain an uncertainty of each state transition, and estimate a degree of confidence in the plan output by the AI. Regarding the uncertainty, an estimation method utilizing known ensemble learning or the like is used.

In the present embodiment, the state transition for one time step and the Q-value are shown, but interpretability may be further improved by presenting a series of the plurality of time steps. In this case, a method in which the explanation process in FIG. 10 is repeated any number of times, or a condition is specified by the environment data 1012 or the scenario selection condition 1043 is exemplified.

In the present embodiment, it is mainly assumed that one state transition is specified for each individual evaluation model, but a plurality of state transitions may be specified for each individual evaluation model. In the explanation stage, which state transition is to be used is specified based on the scenario selection condition 1043. The plurality of state transitions may be displayed instead of only one state transition.

The obtained Q-value vector can be utilized not only for explanation but also as a hint that determines a policy for additional learning for the purpose of improving a performance of the plan generation agent 1011. For example, when the Q-value is small with respect to a future event considered to be important from the viewpoint of a skilled person, by displaying the state transition as answer data, the user can determine a policy so as to additionally learn an episode in which the event occurs.

### Second Embodiment

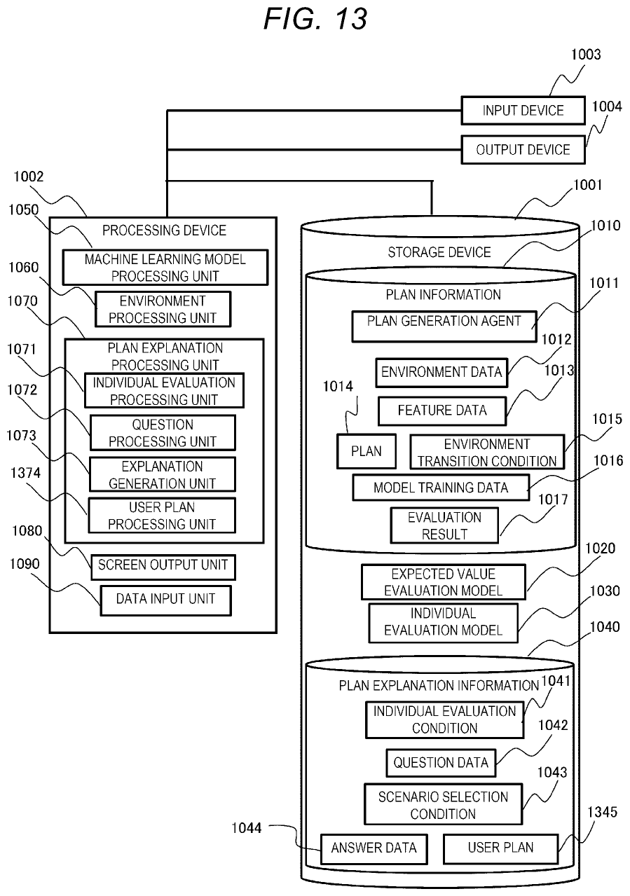

FIG. 13 is a block diagram showing a machine learning system evaluation device according to a second embodiment. In the present embodiment, a method of improving interpretability of the plan 1014 output by an AI as compared with a plan assumed by a user will be described.

As an example for carrying out the second embodiment, the device shown in FIG. 13, which is an extension of FIG. 1, is used. As additional points from the device diagram of FIG. 1, there are a user plan 1345 in the plan explanation information 1040 of the storage device 1001 and a user plan processing unit 1374 in the plan explanation processing unit 1070 of the processing device 1002. These specific utilization methods will be described in the following description.

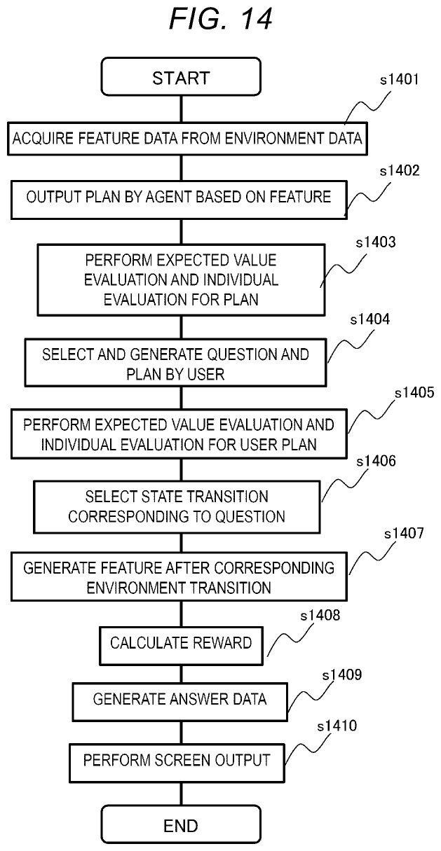

FIG. 14 is a flowchart illustrating an example of an explanation process as compared with a user plan. Since many processes are similar to those in FIG. 10, only differences will be described in detail.

Steps s1401 to s1403 are the same as Steps s101 to s103 in FIG. 10.

Step s1404: the user inputs the user plan 1345 assumed by the user in addition to the question data 1042. A data format of the user plan 1345 is the same as that of the plan 1014 output by the AI.

Step s1405: the expected value evaluation model 1020 and the individual evaluation model 1030 output a Q-value to the user plan 1345.

Step s1406: the question processing unit 1072 compares individually evaluated Q-value vectors of the plan 1014 output by the AI and the user plan 1345 and selects an appropriate state transition with the question data 1042 from the user and the scenario selection condition 1043 (see FIG. 10) as inputs. For example, in a case of a question “why is the plan output by the AI better than the user plan”, by selecting a state transition that has a large Q-value in the plan 1014 output by the AI and a low Q-value in the user plan 1345, it is possible to indicate items having a large difference in future events intended by plans.

Steps s1407 to s1410 are the same as Steps s106 to s109 in FIG. 10. For the user plan 1345, the user plan processing unit 1374 performs the same processing as the plan output by the AI, and adds a processing result to answer data.

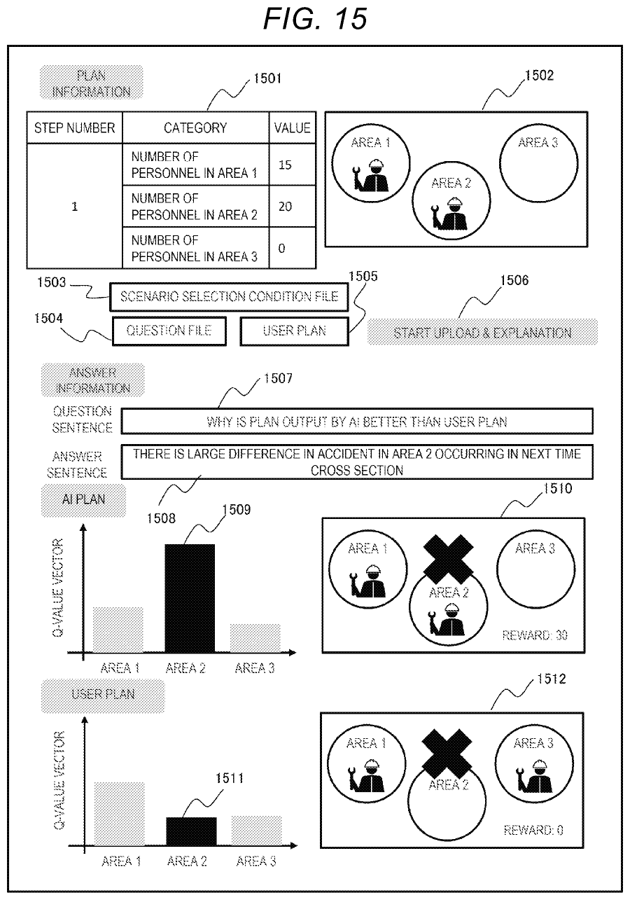

FIG. 15 is a diagram showing an example of a screen output of an explanation as compared with the user plan 1345. The screen output includes an example 1501 of the plan 1014 output by the AI, an example 1502 in which the plan 1014 is graphically visualized, a file input unit 1503 of the scenario selection condition 1043, a file input unit 1504 of the question data 1042 from the user, a file input unit 1505 of the user plan 1345 assumed by the user, a button 1506 for starting file upload and explanation, a display example 1507 of a question sentence from the user, an answer sentence 1508, a Q-value vector 1509 of the plan output by the AI in which the selected state transition is highlighted, an example 1510 in which an environment after the selected state transition and a reward of the plan output by the AI are graphically visualized, a Q-value vector 1511 of the user plan 1345 in which the selected state transition is highlighted, and an example 1512 in which an environment after the selected state transition and a reward of the user plan are graphically visualized. First, the user uploads the scenario selection condition 1043 and the question data 1042 to the output plan 1014. Next, the question processing unit 1072 determines a state transition while comparing with the scenario selection condition 1043, and shows the answer sentence 1508 to the visualization example 1512 as the answer data 1044. In the example, by selecting state transitions having the largest difference in future events intended by plans, information for interpreting an intention of the AI is presented to the question “why is the plan output by the AI better than the user plan”. The items may be displayed on different screens.

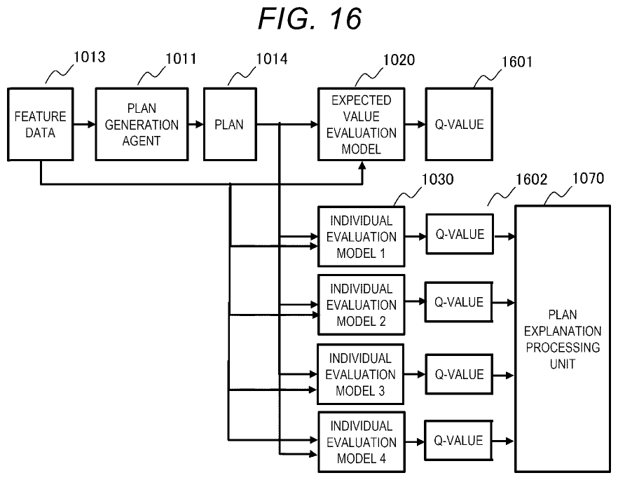

FIG. 16 is a block diagram conceptually illustrating a configuration of the embodiment described in FIG. 10. In the configuration of the embodiment, reinforcement learning known as an actor-critic is applied. The actor critic is a reinforcement learning framework including an actor that selects and executes an action based on a state observed from an environment and a critic that evaluates the action selected by the actor. The actor optimizes the plan (action) based on the evaluation.

In the embodiment, the plan generation agent 1011 corresponds to the actor. The plan generation agent 1011 generates the plan 1014 with the feature data 1013 created based on the environment data 1012 as an input. The environment processing unit 1060 generates the feature data 1013 for a next time step (state transition occurs) based on the plan 1014, the data 1012V that changes over time in the environment data, and the environment transition condition 1015.

The expected value evaluation model 1020 corresponds to the critic 1603. In the already described embodiment, the expected value evaluation model 1020 outputs a Q-value 1601 representing the goodness of the plan (action) in the state with the feature data 1013 and the plan 1014 as inputs. Here, the Q-value 1601 to be output by the expected value evaluation model 1020 indicates an expected value for all state transition functions.

In the embodiment, as described above, one or more individual evaluation models 1030 are provided, and a function of an XAI is implemented. The individual evaluation model 1030 is a machine learning model that divides and evaluates the plan 1014 output by the plan generation agent 1011 for each state transition based on any condition. In other words, an individual evaluation model is a model that evaluates a fixed part of stochastic state transitions based on an evaluation of an expected value evaluation model.

While the expected value evaluation model 1020 evaluates the Q-value as an expected value by viewing the entire stochastic state transitions, the individual evaluation model 1030 fixes a part of stochastic state transitions assuming that the part of the stochastic state transitions occur and evaluates the Q-value at the time. Based on Q-values 1602 to be output by the respective individual evaluation models 1030, the plan explanation processing unit 1070 generates explanation information for the plan 1014 of the plan generation agent 1011.

Since the individual evaluation models 1030 perform evaluation based on different scenarios, respectively, it is possible to know to which scenario the plan 1014 output by the plan generation agent 1011 is meaningful based on the Q-values 1602 to be output by the respective individual evaluation models 1030.

According to the above embodiments, by using an agent portion that outputs an action or a plan in accordance with a state observed based on an environment with state transitions based on conditions such as a probability, a portion that specifies an individual evaluation condition of the plan based on an interest of a user, an individual evaluation model portion that estimates a value of each future state transition, a portion that processes a question from the user, a portion that selects an individual evaluation model with a state transition corresponding to the processed result and calculates a future state and a reward, and a portion that generates explanation of an intention of the action or the plan using the obtained information, it is possible to present a specific future scenario assumed by an AI in accordance with the interest of the user in order to interpret the intention of the action or the plan output by a machine learning system based on reinforcement learning.

According to the above embodiments, since the output of the machine learning model can be easily interpreted for each scenario, it is possible to formulate an efficient plan, reduce energy consumption, reduce carbon emissions, prevent global warming, and contribute to implement of a sustainable society.

1. An information processing device comprising:
an agent configured to output a response based on a state observed from an environment with stochastic state transitions;
an individual evaluation model configured to evaluate the response assuming that a part of the stochastic state transitions occurs; and
a plan explanation processing unit configured to output information based on the evaluation in association with information based on the response.

2. The information processing device according to claim 1, wherein
the agent and the individual evaluation model are machine learning models,
the state is a feature obtained based on the environment, and
the individual evaluation model evaluates the response with the feature and the response as inputs.

3. The information processing device according to claim 2, wherein
the individual evaluation model evaluates the response using a Q-value.

4. The information processing device according to claim 2, wherein
a plurality of types of the individual evaluation models are provided, and
the plan explanation processing unit includes a question processing unit configured to receive a question from a user and select a predetermined individual evaluation model from the plurality of individual evaluation models based on the question.

5. The information processing device according to claim 2, wherein
a plurality of types of the individual evaluation models are provided, and
the plan explanation processing unit includes an explanation generation unit configured to output an explanation regarding an individual evaluation model in which the evaluation satisfies a predetermined condition.

6. The information processing device according to claim 2, wherein
a plurality of types of the individual evaluation models are provided, and
the plan explanation processing unit includes an explanation generation unit configured to simultaneously display evaluations of the plurality of types of individual evaluation models.

7. The information processing device according to claim 3, wherein
the plan explanation processing unit includes an explanation generation unit configured to convert the Q-value into another numerical value and output the other numerical value.

8. The information processing device according to claim 2, further comprising:
a user plan processing unit configured to process a user plan including data in the same format as the response, wherein
the user plan processing unit causes the individual evaluation model to evaluate the user plan with the feature and the user plan as inputs, and
the plan explanation processing unit further outputs information based on the evaluation of the user plan.

9. A machine learning method for machine-learning the agent of claim 2, comprising:
when training the agent, the individual evaluation model, and an expected value evaluation model that evaluates a Q-value as an expected value by viewing entire stochastic state transitions,
training the agent and the expected value evaluation model using training data; and
training the individual evaluation model using only a part of the training data.

10. The machine learning method according to claim 9, further comprising:
training the agent and the expected value evaluation model by reinforcement learning by using an actor-critic method.

11. The machine learning method according to claim 10, further comprising:
using an output of the expected value evaluation model when training the individual evaluation model.

12. The machine learning method according to claim 11, further comprising:
training the individual evaluation model while ensuring a consistency of an output of the individual evaluation model and an output of the expected value evaluation model by calculating an error between the outputs.

13. An information processing method executed by an information processing device including a first learning model configured to receive a feature based on an environment with stochastic state transitions and output a response, and a second learning model configured to evaluate the response assuming that a part of the stochastic state transitions is determined, the information processing method comprising:
a first step of causing the first learning model to receive the feature and output the response;
a second step of causing the second learning model to receive the feature and the response to obtain an evaluation value of the response; and
a third step of outputting information based on the evaluation value in association with the response.

14. The information processing method according to claim 13, further comprising:
preparing a plurality of the second learning models, and
executing at least one of outputting the information based on the evaluation value of the second learning model that satisfies a condition specified by a user and outputting information based on the second learning model that outputs an evaluation value that satisfies a condition specified by the user.

15. The information processing method according to claim 13, further comprising:
training the first learning model by reinforcement learning by using an actor-critic method; and
training the second learning model using only data having the determined state transition among training data for learning the first learning model.
